(19) United States
(12) Patent Application Publication
(10) Pub. No.: US 2018/0365374 A1
(43) Pub. Date: Dec. 20, 2018

(54) POSITIVE OPERATIONAL TAXONOMIC UNIT IDENTIFICATION IN METAGENOMICS

(71) Applicant: INTERNATIONAL BUSINESS MACHINES CORPORATION, Armonk, NY (US)

(72) Inventors: Niina S. HAIMINEN, Valhalla, NY (US); Laxmi P. PARIDA, Mohegan Lake, NY (US); Filippo UTRO, Pleasantville, NY (US)

(21) Appl. No.: 15/801,725

(22) Filed: Nov. 2, 2017

Related U.S. Application Data
(63) Continuation of application No. 15/622,247, filed on Jun. 14, 2017.

(51) Int. Cl. G06F 19/14; G06F 19/24; G06F 7/08

(52) U.S. Cl. CPC G06F 19/14; G06F 19/24; G06F 7/08

(57) ABSTRACT

Embodiments of the present invention are directed to a computer-implemented method for positive OTU identification. A non-limiting example of the computer-implemented method includes receiving, by a processor, a plurality of sequencing reads for a metagenome sample and, for each of the plurality of sequencing reads, a corresponding OTU set comprising a plurality of OTUs. The method also includes determining, by the processor, a true positive score for each of the plurality of OTUs based upon a C̆ech Complex and generating a plurality of preliminary OTUs. The method also includes determining a threshold score for the preliminary OTUs. The method also includes removing one of the preliminary OTUs based at least in part upon a determination that the true positive score is less than a threshold. The method also includes retaining one of the preliminary OTUs based at least in part upon a determination that the true positive score is greater than or equal to the threshold.

### DOMESTIC AND/OR FOREIGN PRIORITY

This application is a continuation of U.S. application Ser. No. 15/622,247, titled “Positive Operational Taxonomic Unit Identification in Metagenomics” filed Jun. 14, 2017, the contents of which are incorporated by reference herein in its entirety.

### BACKGROUND

The present invention generally relates to metagenomics data, and more specifically, to positive operational taxonomic unit identification in metagenomics.

Metagenome mapping involves extraction and identification of all genomic sequences from environmental samples. Environmental samples, such as soil samples, food samples, or biological tissue samples can contain extremely large numbers of organisms. For example, it is estimated that the human body, which relies upon bacteria for modulation of digestive, endocrine, and immune functions, can contain up to 100 trillion organisms. In the past decade, advances in sequencing and screening technologies have increased the potential for determining the microbial composition of previously unknown samples. Similar nucleic acid sequences can be clustered into operational taxonomic units (OTUs), which are intended to represent taxonomic units of a species or genus for example.

### SUMMARY

Embodiments of the present invention are directed to a computer-implemented method for positive OTU identification. A non-limiting example of the computer-implemented method includes receiving, by a processor, a plurality of sequencing reads for a metagenome sample and, for each of the plurality of sequencing reads, a corresponding OTU set comprising a plurality of OTUs. The method also includes determining, by the processor, a true positive score for each of the plurality of OTUs based upon a C̆ech Complex and generating a plurality of preliminary OTUs. The method also includes determining a threshold score for the preliminary OTUs. The method also includes removing one of the preliminary OTUs based at least in part upon a determination that the true positive score is less than a threshold. The method also includes retaining one of the preliminary OTUs based at least in part upon a determination that the true positive score is greater than or equal to the threshold.

Embodiments of the invention are directed to a computer program product for positive OTU identification, the computer program product including a computer readable storage medium having program instructions embodied therewith. The program instructions are executable by a processor to cause the processor to perform a method. A non-limiting example of the method includes receiving a plurality of sequencing reads for a metagenome sample and, for each of the plurality of sequencing reads, a corresponding OTU set comprising a plurality of OTUs. The method also includes determining a true positive score for each of the plurality of OTUs based upon a C̆ech Complex and generating a plurality of preliminary OTUs. The method also includes determining a threshold score for the preliminary OTUs. The method also includes removing one of the preliminary OTUs based at least in part upon a determination that the true positive score is less than a threshold. The method also includes for one of the plurality of preliminary OTUs, based at least in part upon a determination that the true positive score is greater than or equal to the threshold, retaining the OTU as a true positive OTU.

Embodiments of the invention are directed to a processing system for positive OTU identification. A non-limiting example of the processing system includes a processor in communication with one or more types of memory. The processor can be configured to perform a method. A non-limiting example of the method includes receiving a plurality of sequencing reads for a metagenome sample and, for each of the plurality of sequencing reads, a corresponding OTU set comprising a plurality of OTUs. The method also includes determining a true positive score for each of the plurality of OTUs based upon a C̆ech Complex Complex and generating a plurality of preliminary OTUs. The method also includes determining a threshold score for the preliminary OTUs. The method also includes removing one of the preliminary OTUs based at least in part upon a determination that the true positive score is less than a threshold. The method also includes retaining one of the preliminary OTUs based at least in part upon a determination that the true positive score is greater than or equal to the threshold.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram illustrating one example of a processing system for practice of the teachings herein according to some embodiments of the invention;

FIG. 2 depicts a flow diagram illustrating a method according to some embodiments of the invention;

FIG. 3 depicts a block diagram illustrating an exemplary system according to some embodiments of the invention;

FIG. 4 depicts a schematic illustrating a method according to some embodiments of the invention;

FIG. 5 depicts a schematic illustrating a method according to some embodiments of the invention; and

FIG. 6 depicts a flow diagram illustrating a method according to some embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” can include any integer number greater than or equal to one, i.e. one, two, three, four, etc. The terms “a plurality” can include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, metagenomics, the study of genomic species obtained directly from the environment, is a desirable area of study that can be computationally and experimentally challenging. Current methods are subject to problems of sensitivity, specificity and interpretation.

Metagenome sequencing can be performed in multiple stages. First, an environmental sample can be prepared. For instance, DNA from a sample can be isolated and then fragmented to obtain sequence fragments small enough for current sequencing techniques. Thereafter, sample preparation can include blunting the fragment ends and ligating adaptors to the DNA fragments, for instance, to enable substrate attachment in sequencing applications. Next, the prepared samples can be sequenced. Sequencing generally includes High Throughput Sequencing methods. Further, the sequence data can be analyzed with bioinformatics to identify and further analyze the genomic content of a sample. The reads from metagenomics samples can be mapped to their respective gene, or a species, genus, or other taxonomic entity (OTU, Operational Taxonomic Unit).

Sources of difficulty in mapping include, for example, problems with the comparative databases such as redundant candidates or inaccuracies. As a result, sequences can align with multiple OTUs in a database. In addition, many different environmental strains contain significant and extensive genetic overlap, posing challenges to proper identification. Moreover, sequence errors can be introduced during the extraction process or in other biotechnological steps. As a result, current solution pipelines yield mapping results riddled with false positives, which can represent up to 95% of a predicted OTU set.

Turning now to an overview of the aspects of the invention, one or more embodiments of the invention address the above-described shortcomings of the prior art by providing a method for discriminating between true positive and false positive OTU identifications with application of a C̆ech Complex to an initial OTU set and contextually filtering the true positives based upon the resultant OTU output. The above-described aspects of the invention can provide highly accurate OTU identification from a metagenomic sample and reduce or eliminate the presence of false positive OTU identification.

Embodiments of the invention can provide a more accurate understanding of the contents of environmental data. For example, embodiments of the invention can provide enhanced and improved identification of pathogens in food safety applications and/or to provide improved diagnostics in investigation of human health studies.

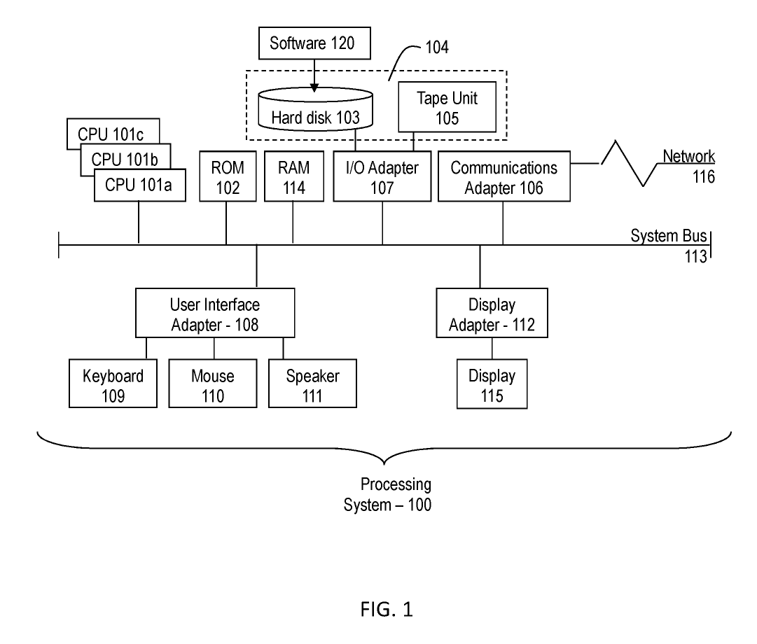

Turning now to a more detailed description of aspects of the present invention, FIG. 1 depicts an embodiment of a processing system 100 for implementing the teachings herein. In this embodiment of the invention, the system 100 has one or more central processing units (processors) 101a, 101b, 101c, etc. (collectively or generically referred to as processor(s) 101). In one embodiment of the invention, each processor 101 can include a reduced instruction set computer (RISC) microprocessor. Processors 101 are coupled to system memory 114 and various other components via a system bus 113. Read only memory (ROM) 102 is coupled to the system bus 113 and can include a basic input/output system (BIOS), which controls certain basic functions of system 100.

FIG. 1 further depicts an input/output (I/O) adapter 107 and a network adapter 106 coupled to the system bus 113. I/O adapter 107 can be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 can be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which can include a graphics adapter to improve the performance of graphics intensive applications and a video controller. In one embodiment of the invention, adapters 107, 106, and 112 can be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which can include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment of the invention, a portion of system memory 114 and mass storage 104 collectively store an operating system such as the AIX® operating system from IBM Corporation to coordinate the functions of the various components shown in FIG. 1.

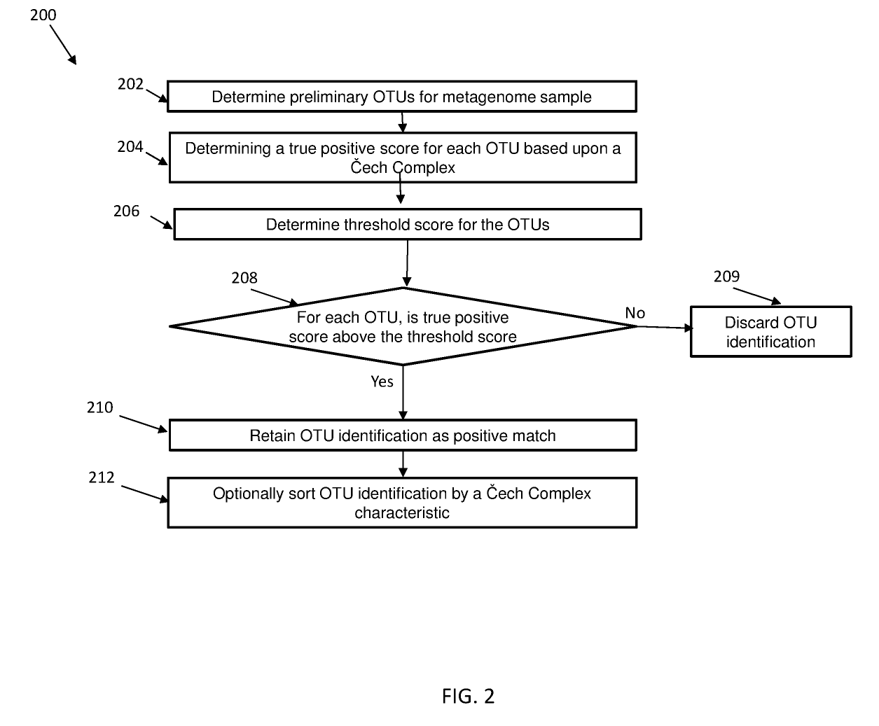

Referring now to FIG. 2, a flow chart illustrating a method 200 for positive OTU identification in metagenomics according to exemplary embodiments of the present invention is shown. As shown at block 202, the method 200 includes determining preliminary OTUs for a metagenome sample. Next, as shown at block 204, the method 200 includes determining a true positive score for each OTU based upon a C̆ech Complex. As shown at block 206, the method 200 includes determining a threshold score for the OTUs. The threshold score can be a contextual threshold score in some embodiments of the invention and can, for example, depend upon one or more features of the metagenomic sample or the OTUs. The threshold score is a number above which an OTU identification has the desired likelihood of representing a true positive match.

The method 200 includes, as shown at decision block 208, determining for each OTU whether the true positive score exceeds the threshold score. If the true positive score is less than the threshold score, the method 200 proceeds to block 209 and the OTU is discarded. If the true positive score exceeds the threshold score, the OTU identification is retained as a positive match, as shown at block 210. In some embodiments of the invention, the method 200 includes sorting the OTU identifications by a characteristic, such as a C̆ech Complex characteristic. For instance, the OTU identifications can be sorted by frequency, filtration time, true positive score, and the like.

Determining a true positive score can include applying a C̆ech Complex on the OTUs. In some embodiments of the invention determining a true positive score (tp) for each OTU X includes, in a bar code of an OTU, wherein b is the h-simplex=X₀X₁. . . Xₕ with bar length denoted as len(b), determining the true positive score as follows:

tp(X)=Σₕ(Σ_{bϵH}_{_{h,}}_{xϵb}h×len(b))

In some embodiments of the invention, the method 200 eliminates all false positive OTU identifications. In some embodiments of the invention, the method 200 retains all true positive OTU identifications. In some embodiments of the invention, the method 200 eliminates all false positive OTU identifications and retains all true positive OTU identifications.

In some embodiments of the invention, a method includes outputting positive OTU identifications, for instance, to a display.

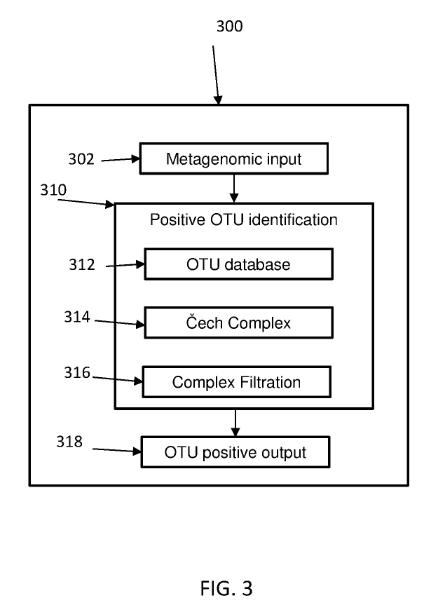

Referring now to FIG. 3, a block diagram of an exemplary system 300 for positive OTU identification is shown. In exemplary embodiments of the invention, the system 300 can be embodied in a smartphone, a processing system (similar to the one shown in FIG. 1), a laptop, a tablet, or any other suitable device that includes a processor and memory. In exemplary embodiments of the invention, the system 300 includes a metagenomic input interface 302. The exemplary system 300 also includes a positive OTU identification module 310.

The positive OTU identification module 310 can include, for example, an OTU database 312. The OTU database 312 includes any database containing known partial or complete DNA sequence information for multiple OTUs. The exemplary system 300 can also include a C̆ech Complex engine 314. The C̆ech Complex engine can calculate a true positive score for each OTU by applying a C̆ech Complex to the OTUs, for instance OTUs obtained or derived from the user interface. The positive OTU identification module 310 can also include a complex filtration engine 316. In some embodiments of the invention, the complex filtration engine can filter an OTU identification list based at least in part upon the true positive score. In some embodiments of the invention, the complex filtration engine removes OTU identifications having a true positive score less than or equal to a threshold, such as a contextual threshold. The system 300 also includes an OTU positive output 318. The OTU positive output can provide OTU identifications not discarded by the complex filtration engine 318.

In some embodiments of the invention, the system 300 eliminates all false positive OTU identifications. In some embodiments of the invention, the system 300 retains all true positive OTU identifications. In some embodiments of the invention, the system eliminates all false positive OTU identifications and retains all true positive OTU identifications. In some embodiments of the invention, the OTU positive output 318 contains no false positives.

Embodiments of the invention can filter preliminary OTU identifications with 100s or 1000s of identifications, or nodes.

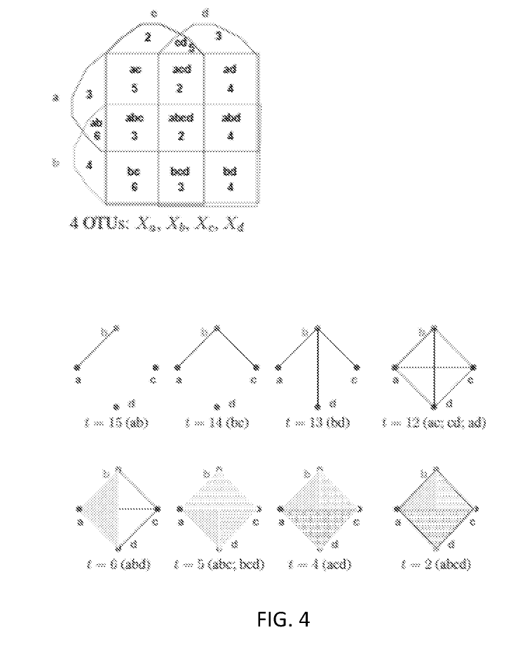

FIG. 4 illustrates aspects of positive OTU identification according to some embodiments of the invention. For illustrative purposes, FIG. 4 includes a preliminary OTU identification subset including only four nodes although, as noted above, embodiments of the invention can filter thousands of OTU identifications in some embodiments of the invention. As is shown in the upper left corner of FIG. 4, four OTUs, Xₐ, X_{b}, X_{c}, and X_{d} have a certain number of sequencing reads that match them. For instance, as shown in FIG. 4, five sequencing reads match Xₐ and X_{c} (and not X_{b} or X_{d}). After application of a C̆ech Complex to the OTUs, the C̆ech Complex can be filtered by applying a threshold. A plurality of surfaces can be determined for combinations of nodes a through d (bottom of FIG. 4).

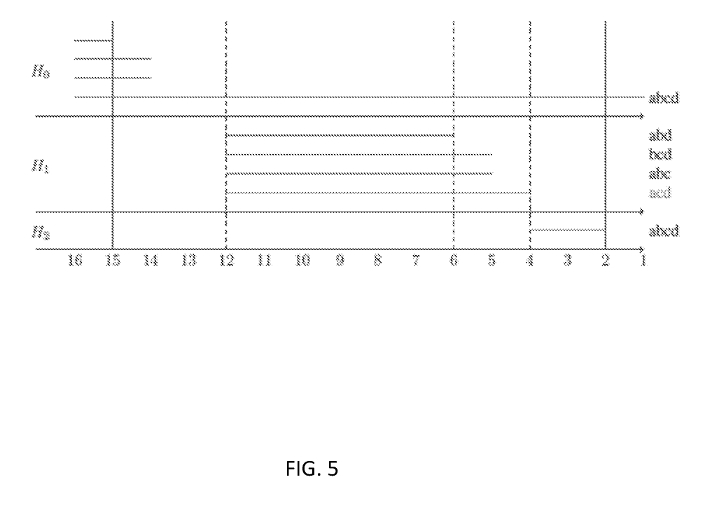

The surfaces can also be represented by a bar code, as illustrated in FIG. 5. The bar code is a graphical representation of a filtration set. FIG. 5 illustrates resultant bar codes of the four OTUs depicted in FIG. 4 and filtrations on an associated C̆ech Complex. FIG. 5 represents resultant true positive scores of nodes a through d as follows:

tp(a)=63

tp(b)=60

tp(c)=66

tp(d)=63.

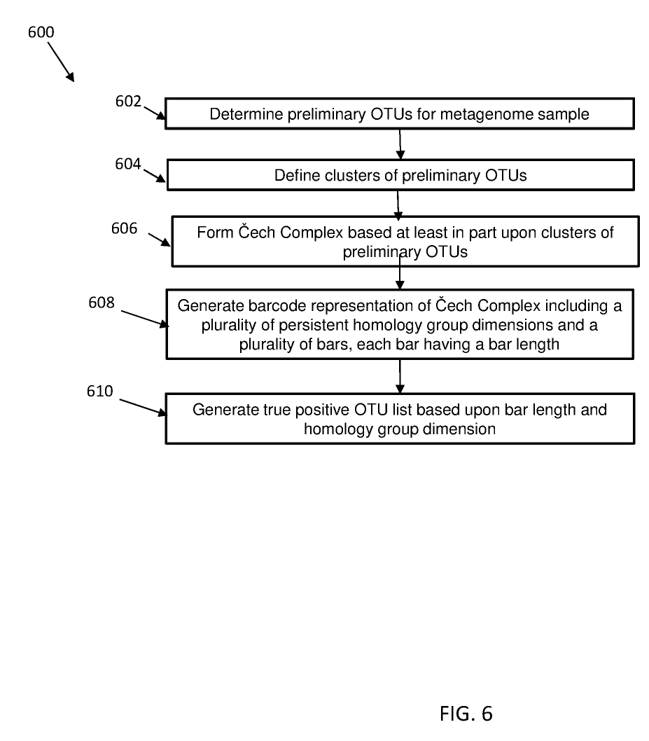

FIG. 6 illustrates a method 600 for positive OTU identification in metagenomics according to exemplary embodiments of the present invention. The method 600 can include determining preliminary OTUs for a metagenome sample, as shown in block 602. The method 600 can also include defining clusters of preliminary OTUs, as shown in block 604. The method 600 can also include, as shown at block 606, forming a C̆ech complex based at least in part upon the clusters of preliminary OTUs. The method 600 can also include, as shown at block 608, generating a barcode representation of the C̆ech complex including a plurality of persistent homology group dimensions and a plurality of bars, each bar having a bar length. The method 600 can also include, as shown at block 610, generating a true positive OTU list based upon the bar lengths and homology group dimensions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments of the invention, the practical application or technical improvement over technologies found in the marketplace, or to enable others of ordinary skill in the art to understand the embodiments described herein.

What is claimed is:

1. A computer-implemented method for positive operational taxonomic unit (OTU) identification, the method comprising:
receiving, by a processor, a plurality of sequencing reads for a metagenome sample and, for each of the plurality of sequencing reads, a corresponding OTU set comprising a plurality of OTUs;
determining, by the processor, a true positive score for each of the plurality of OTUs based upon a C̆ech Complex and generating a plurality of preliminary OTUs;
determining, by the processor, a threshold score for the preliminary OTUs;
removing one of the preliminary OTUs based at least in part upon a determination that the true positive score is less than a threshold; and
retaining one of the preliminary OTUs as a true positive OTU based at least in part upon a determination that the true positive score is greater than or equal to the threshold.

2. The computer implemented method of claim 1 further comprising sorting the true positive OTUs.

3. The computer implemented method of claim 2, wherein sorting comprising sorting the true positive OTUs based at least in part upon OTU frequency.

4. The computer implemented method of claim 2, wherein sorting comprising sorting the true positive OTUs based at least in part upon OTU filtration time.

5. The computer-implemented method of claim 1, wherein the preliminary OTUs comprises a preliminary identification of an OTU in a food sample.

6. The computer-implemented method of claim 1, wherein the true positive score of an OTU X is
tp(X)=Σₕ(Σ_{bϵH}_{_{h,}}_{xϵb}h×len(b))
wherein b is the h-simplex=X₀X₁. . . Xₕ, and len(b) is a bar length of b.

7. The computer-implemented method of claim 1, wherein the threshold is determined based at least in part upon the preliminary OTUs.
